(19) United States
(12) Patent Application Publication
(10) Pub. No.: US 2026/0113731 A1
(43) Pub. Date: Apr. 23, 2026

(54) SIGNALLING REDUCTION FOR FIXED WIRELESS ACCESS DEVICES

(71) Applicant: T-MOBILE INNOVATIONS LLC, Overland Park, KS (US)

(72) Inventor: Jasinder Pal SINGH, Olathe, KS (US)

(21) Appl. No.: 18/924,523

(22) Filed: Oct. 23, 2024

(51) Int. Cl. H04W 68/02; H04W 24/02; H04W 24/10

(52) U.S. Cl. CPC H04W 68/02; H04W 24/02; H04W 24/10

(57) ABSTRACT

Methods, media, and systems are provided for facilitating signaling reduction for fixed wireless access (FWA) devices. Based on an attempted communication from a sending device to an FWA device, a node in a telecommunications network that most recently served the FWA device is identified. A first page is then communicated to the node. If a response has not been received from the node based on the first page, a second page is communicated to the node.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to facilitating signaling reduction for Fixed Wireless Access (FWA) devices, substantially as shown in and/or described in connection with at least one of the figures, and as set forth more completely in the claims.

In aspects set forth herein, and at a high level, the technology described herein relates to facilitating signaling reduction for an FWA device. While typically, when a first device is attempting to call or otherwise communicate with a second device, the network may send a page to a node that has most recently served the second device, then expand the reach of another page to a tracking area associated with the second device, and then another page to neighboring nodes/cells. But, when the second device is an FWA device, or another device that is not typically mobile, this existing paging system is overly complex, leading to network inefficiencies. Here, aspects are disclosed where an FWA device is distinguished from a mobile device such that the paging techniques can be tailored based on a mobility of the device. For FWA devices, for example, subsequent pages may be communicated only to the last known node of the FWA device, and then potentially neighboring nodes.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for facilitating signaling reduction for FWA devices in a wireless telecommunication network, in accordance with aspects herein;

FIG. 2 illustrates an example flowchart for facilitating signaling reduction for FWA devices in a wireless telecommunication network, in accordance with aspects herein;

FIG. 3 illustrates another example flowchart facilitating signaling reduction for FWA devices in a wireless telecommunication network, in accordance with aspects herein;

FIG. 4 illustrates another example flowchart for facilitating signaling reduction for FWA devices in a wireless telecommunication network, in accordance with aspects herein; and

FIG. 5 depicts an example computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In cellular networks, paging is the process used by the network to notify a device when it has incoming communication (e.g., a call, SMS, or data request). The paging mechanism operates both in the uplink and downlink to ensure that communication can be initiated between the device and the network. Specifically for downlink paging (e.g., Network to device communication), when the network (core network or Radio Access Network, RAN) needs to establish communication with a device, such as an incoming call or data, it sends a paging message to locate the device. The process involves the network sending a paging message to a last known node, such as a node that last served the device, then sending a paging message to a specific group of cells, such as neighboring nodes, and then nodes within the area where the device is last known to be registered (e.g., tracking area)), and then potentially to a much larger grouping of nodes (market area). This paging message contains the Temporary Mobile Subscriber Identity (TMSI) or Paging-RNTI (Radio Network Temporary Identifier). When the device detects its identifier in the paging message, it transitions from idle to connected mode and sends an uplink message (RRC connection request) to the network to establish communication. This allows the device to receive the incoming data or voice call.

For uplink communications, when the UE initiates communication (such as when sending data or making a call), it usually performs the random access procedure if the UE is in idle mode to establish a connection with the network. This involves selecting a random Physical Random Access Channel (PRACH) preamble and sending it in the uplink to the network. Once the network receives the PRACH preamble, it sends a Random Access Response (RAR) to the device, which includes timing information and resources for the UE to send its uplink data. This establishes a Radio Resource Control (RRC) connection, allowing the UE to start sending data in the uplink.

One key component of paging includes a Paging Channel (PCH), which is the downlink channel where the network broadcasts paging messages to all devices in a cell or group of cells. In 5G NR, paging follows a similar process as in LTE but with some benefits. These include beamforming in 5G, allowing better targeting of paging messages and improved coverage, Massive MIMO (Multiple Input Multiple Output), which improves the capacity of handling paging for a large number of devices, and energy efficiency improving where devices can operate with better power-saving mechanisms.

While typically, no distinction is made between device types when it comes to paging mechanisms, this causes network resources to be utilized even when not needed. For example, when a first device is attempting to call or otherwise communicate with a second device, the network may send a page to a node that has most recently served the second device, then expand the reach of another page to a tracking area associated with the second device, another page to neighboring nodes/cells, and still other pages to larger groupings of nodes. The traditional paging systems assume that the device will be mobile, such as the vast majority of devices that are connected to the network and that receive communications. But, when the second device is an FWA device, or another device that is not typically mobile, this existing paging system is overly complex, leading to network inefficiencies. Here, aspects are disclosed where an FWA device is distinguished from a mobile device such that the paging techniques can be tailored based on a mobility of the device. For FWA devices, for example, an assumption can be made that the FWA device has not moved since it was last connected to a node. Therefore, after a first page to the last known node, subsequent pages may be communicated only to the last known node and potentially neighboring nodes, but not outside of that grouping of nodes.

In an additional aspect provided herein, because of the assumption that an FWA device is not mobile, if the FWA device should detect in itself that its location has been modified (e.g., moving to a different floor, building, side of building), the FWA device can send a measurement report to the network. The sending of the measurement report can indicate to the network that the FWA device's location has been modified. This may happen, for example, on the uplink, where once the FWA device or other stationary user has reached its highest preferred frequency, the node may signal to the device to increase the measurement report periodicity by some number (e.g., 10 times) that is configurable, or the node instructs the FWA device to only send a measurement report when it detects movement in itself. This way, the FWA device or other stationary device doesn't send frequent measurement reports to the node.

By way of background, FWA is a type of wireless communication technology that provides broadband internet access to fixed locations, such as homes, offices, and other buildings. Unlike traditional wired broadband services (e.g., DSL, cable, or fiber), FWA uses wireless radio links to connect end-users to the internet. This technology is particularly beneficial in rural or remote areas where laying down wired infrastructure is challenging and costly. The evolution of FWA technology has been driven by advances in wireless communication standards, including 4G LTE and, more recently, 5G. These advancements have significantly improved the bandwidth, latency, and reliability of FWA services, making them a viable alternative to wired broadband in many scenarios. The deployment of FWA has facilitated the bridging of the digital divide by providing high-speed internet access to underserved and unserved regions.

An FWA system primarily comprises two components: the base station (or access point) and the fixed wireless access device (also known as Customer Premises Equipment, or CPE). The base station is a central node that transmits and receives wireless signals to and from multiple FWA devices. It is connected to the core network and the internet backbone. The FWA device is installed at the user's premises. It communicates wirelessly with the base station to provide internet connectivity to the end-user devices, such as computers, smartphones, smart TVs, and other internet-enabled devices within the premises.

The FWA device serves as the intermediary between the user's internal network and the base station. It receives data from the base station and transmits it to the user's devices and vice versa. For optimal performance, FWA devices are usually installed in locations with clear line-of-sight to the base station, such as rooftops or external walls.

FWA devices (e.g., High Speed Internet (HINT) Devices) play a crucial role in the delivery of high-speed internet to fixed locations, especially in areas lacking traditional broadband infrastructure. The continuous exchange of detailed operational data between FWA devices and the base station ensures robust, reliable, and high-performance internet connectivity, thereby enhancing the overall user experience. As FWA technology continues to evolve, the integration of advanced data analytics and AI-driven network management will further optimize the performance and reliability of FWA systems.

Various components may be involved in FWA systems. For exemplary purposes only, some of these components may include a base station that acts as the central hub connected to the internet backbone, and is equipped with antennas to transmit and receive signals over a wide area. The FWA device itself may be installed at the user's premises (home, office, etc.), and it may communicates wirelessly with the base station. Further, the FWA device connects to internal devices through wired (Ethernet) or wireless (Wi-Fi) connections.

The operational workflow for FWA devices includes signal transmission from the base station to the FWA device. The base station emits radio signals that cover a defined service area. These signals carry data to and from the internet. The FWA device, equipped with an antenna, receives these radio signals. Optimal placement of the FWA device is crucial, often requiring line-of-sight to the base station to minimize signal obstruction and interference. The received signals are processed by the FWA device, converting the radio waves into digital data. This involves demodulation, error correction, and data decoding to ensure accurate and efficient data transfer. The processed data is distributed to internal devices (e.g., computers, smartphones, smart TVs) within the user's premises. This distribution can occur via Wi-Fi or Ethernet. For Wi-Fi distribution, the wireless signals within the premises allow mobile and stationary devices to connect without cables. For Ethernet, there are wired connections to devices that support or require stable, high-speed internet access. When a user device requests data (e.g., browsing the internet, streaming video), the FWA device aggregates this data and transmits it back to the base station. The FWA device modulates and encodes the data into radio signals suitable for transmission. The base station receives the data from the FWA device, processes it, and routes it to the appropriate destination on the internet. Responses from the internet are similarly processed and sent back to the FWA device, completing the data exchange cycle.

Modern FWA devices often use advanced antenna technologies, such as Multiple Input Multiple Output (MIMO) and beamforming, to enhance signal strength, range, and reliability. Moreover, FWA devices operate in licensed and unlicensed frequency bands, including sub-6 GHZ and millimeter-wave (mmWave) frequencies. The choice of frequency band affects coverage, bandwidth, and penetration capabilities. FWA systems may implement QoS mechanisms to prioritize critical traffic, manage bandwidth allocation, and ensure consistent performance for various applications (e.g., video conferencing, online gaming). Data encryption and secure communication protocols protect user data from interception and unauthorized access. FWA devices can be remotely monitored and updated by service providers, ensuring they run the latest firmware and configuration settings for optimal performance and security.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

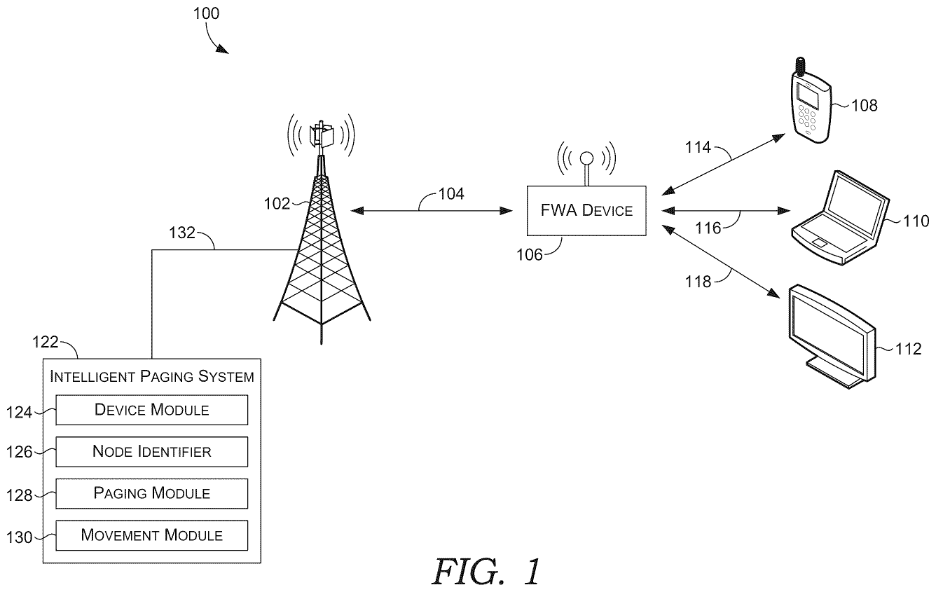

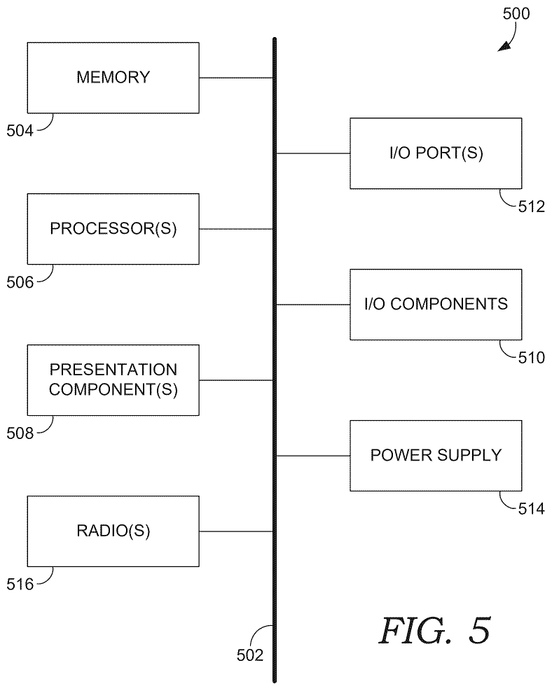

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user devices 108, 110, or 112 described herein with respect to FIG. 1. A user device may also be, in another embodiment, similar to user device 500, described herein with respect to FIG. 5.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1x Advanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1x circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

In a first aspect, a method is provided for facilitating signaling reduction for FWA and other stationary devices. Based on an attempted communication from a sending device to an FWA device, the method includes identifying a node in a telecommunications network that most recently served the FWA device. The method also includes communicating a first page to the node, and determining that a response has not been received from the node based on the first page. The method additionally includes communicating a second page to the node.

In a second aspect, a system is provided for facilitating signaling reduction for FWA devices. The system includes a network component associated with a wireless telecommunication network, one or more processors communicatively coupled with the network component, and computer memory storing computer-usable instructions that, when executed by the one or more processors, perform operations of a method. The method includes, based on an attempted communication from a sending device to an FWA device, identifying a first node that most recently served the FWA device, and receiving a measurement report corresponding to the FWA device, the receipt of the measurement report indicating that the FWA device's location has been modified since the first node served the FWA device. Further, the method includes, based on the FWA device's location being modified, identifying a set of nodes neighboring the first node, and communicating a page to the set of nodes.

In a third aspect, one or more non-transitory computer storage media having computer-executable instructions embodied thereon is provided, that when executed by at least one processor, cause the at least one processor to perform a method. The method incudes, based on an attempted communication from a sending device to a receiving device that is served by an FWA device, determining a node in a telecommunications network that most recently served the FWA device, communicating a first page to the node, and determining that a response has not been received from the node based on the first page. The method further includes, based on an inference that the FWA device has likely not been moved since the node most recently served the FWA device, communicating a second page to the node.

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for facilitating signaling reduction for FWA device within a wireless telecommunications network. The system includes components and interactions between the FWA device and a network node to reduce signaling, and more specifically, paging messages sent to stationary devices, such as FWA devices. Network environment 100 includes node 102 (e.g., base station), an FWA device 106, user devices 108, 110, and 112, and intelligent paging system 122.

As mentioned, network environment 100 includes user devices 108, 110, and 112. In network environment 100, user devices 108, 110, and 112 may take on multiple forms, such as cameras, microphones, sensors, googles, and glasses, to name a few, or any other device (such as the computing device (500) that communicates via wireless communications with the FWA device 106 in order to interact with a public or private network.

In some aspects, each of the user devices 108, 110, and 112 may correspond to computing device 500 in FIG. 5. Thus, user device can include, for example, a display(s), a power source(s) (e.g., a battery), a data store(s), a speaker(s), memory, a buffer(s), a radio(s) and the like. In some implementations, for example, user devices 108, 110, and 112 comprise a wireless or mobile device with which a wireless telecommunication network(s) can be utilized for communication (e.g., voice and/or data communication). In this regard, the user devices 108, 110, and 112 can be any mobile computing device that communicates by way of a wireless network, for example, a 3G, 4G, 5G, 6G, LTE, CDMA, or any other type of network. In some cases, user devices 108, 110, and 112 in network environment 100 can optionally utilize one or more communication channels (not shown) to communicate with other computing devices (e.g., a mobile device(s), a server(s), a personal computer(s), etc.) through the FWA device 106 and node 102. Node 102 may be a gNodeB, eNodeB, or the like.

The network environment 100 may be comprised of a telecommunications network(s) (now shown), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

Communication channel 104 can be part of a telecommunication network that connects subscribers to their immediate telecommunications service provider (i.e., home network carrier). In some instances, such as when an FWA device is utilized, the communication channels are associated with a telecommunications provider that provides services (e.g., 3G network, 4G network, LTE network, 5G network, 6G network, and the like) to the FWA device, such as the FWA device 106. For example, the communication channels may provide voice, SMS, and/or data services to the FWA device 106 directly, or to one or more of user devices 108, 110, and 112 through the FWA device 106, or corresponding users that are registered or subscribed to utilize the services provided by the telecommunications service provider. Some devices, such as user devices 108, 110, and 112, connect to the FWA device 106 and receive telecommunications services through this device. The communication channels can comprise, for example, a 1x circuit voice, a 3G network (e.g., CDMA, CDMA2000, WCDMA, GSM, UMTS), a 4G network (WiMAX, LTE, HSDPA), a 5G network or a 6G network. As mentioned, an FWA device may itself receive paging messages from the network. For example, paging messages may be communicated to the FWA device for any software upgrades on the FWA device from the network side, or 5G/4G chipset set firmware upgrades initiated by the network and/or server.

In some implementations, node 102 is configured to communicate with the FWA device 106, which is then used to communicate with user devices 108, 110, and 112 by way of the FWA device 106, which may be located in a same area as the user devices 108, 110, and 112. As such, radio antennas of node 102 may send communications to the FWA device 106, or may send communications to the FWA device 106, which then serves user devices 108, 110, and 112. Node 102 may include one or more base stations, base transmitter stations, radios, antennas, antenna arrays, power amplifiers, transmitters/receivers, digital signal processors, control electronics, GPS equipment, and the like.

The FWA device 106 provides device connectivity to the wireless network to user devices 108, 110, and 112 by way of, for example, communication links 114, 116, and 118. The FWA device 106 serves multiple end-user devices within a specific coverage area, providing broadband wireless connectivity. This device is equipped with components to determine the number of connected devices, request information from them, and communicate with node 102.

Intelligent paging system 122 includes device module 124, node identifier 126, paging module 128, and movement module 130. Device module 124 may be responsible for determining that a first device or a network component (e.g., for a network update) is attempting to communicate with a second device. In one aspect, the second device is FWA device 106 or another stationary device. Once it's determined that a first device or a network component is attempting to communicate with FWA device 106, node identifier 126 identifies a node that most recently served FWA device 106. Here, node identifier 126 would identify node 102 as the last known node. While the term node is used herein as receiving the page, a cell may also be the entity to receive the page. Node identifier 126 may also be instructed to identify one or more other nodes or cells to page, such as for a second or other subsequent page.

Paging module 128 may be responsible for communicating pages to nodes or cells. In one aspect, an Access and Mobility Management Function (AMF) is the responsible network component for paging devices. AMF is a critical component in the 5G core network architecture, as it is responsible for managing several key aspects of device connections, including registration, connection, reachability, and mobility across the network. The AMF plays a similar role to the MME (Mobility Management Entity) in 4G LTE, but with enhanced features and responsibilities in 5G networks. Paging module 128, in addition to communicating paging message, may be responsible for determining which nodes to page, as identified by node identifier 126. As mentioned herein, paging messages for FWA or other stationary devices may be sent to a last known node/cell, and if no response is received, to neighboring nodes/cells. Movement module 130 is responsible for determining whether FWA device 106 has moved since last being connected to a node. As described above, the FWA device 106 may send a measurement report when it determines that its location has been modified. In this instance, the movement module 130 will be able to determine when movement has occurred by the receipt of the measurement report, and can then instruct paging module 128 to use the traditional paging procedure that is used for mobile device. For an FWA device that has been moved, nodes outside of the last known node and neighboring nodes may need to be paged in order for the FWA device to receive the attempted communication.

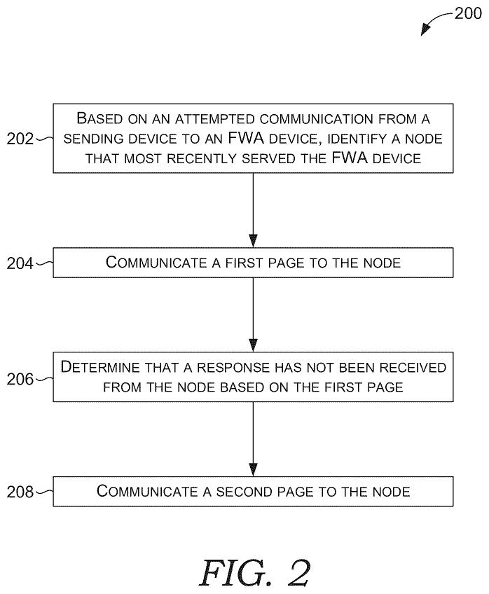

FIG. 2 illustrates an example flowchart of a method 200 for facilitating signaling reduction for an FWA device, in accordance with aspects herein. At block 202, based on san attempted communication from a sending device to an FWA device, a node is identified that most recently served the FWA device. Prior to or after the identification of the node, it may be determined that a receiving device is an FWA device or other stationary device. The determination of the receiving device being an FWA device is made so that the network knows not to utilize the traditional paging practices for mobile devices. In some aspects, an inference is made that the FWA device is not mobile. In some aspects, the attempted communication is a data communication, a voice communication, or an upgrade to software on the FWA device. At block 204, a first page is communicated to the node. At block 206, it is determined that a response has not been received from the node based on the first page. Typically, this indicates that the node is not currently serving the FWA device. At block 208, a second page is communicated to the node, and in some aspects, the second page is communicated to the node without first communicating a page to one or more neighboring nodes or other cells of the node. If no response is received based on the second page, a third page may be communicated to the same node. However, in aspects, a time period between communication of the second page and the third page may be greater than a time period between the communication of the first page and the second page.

In some aspects, a network component may receive a measurement report from the FWA device. Receipt of the measurement report, in aspects, indicates to the network that the FWA device detected that it had been moved, thus triggering a measurement report. If the FWA has been moved, in aspects, a third page may be sent to at least one other node, such as a second node, that is different from the node. The at least one other node where the third page is sent may be one or more nodes that neighbor the last known cell, or may represent a wider geographic area, given that the FWA device has moved. In yet other aspects, historical data corresponding to the FWA device may be used to determine that a probability that the FWA device has moved since the node most recently served the FWA device is below a threshold.

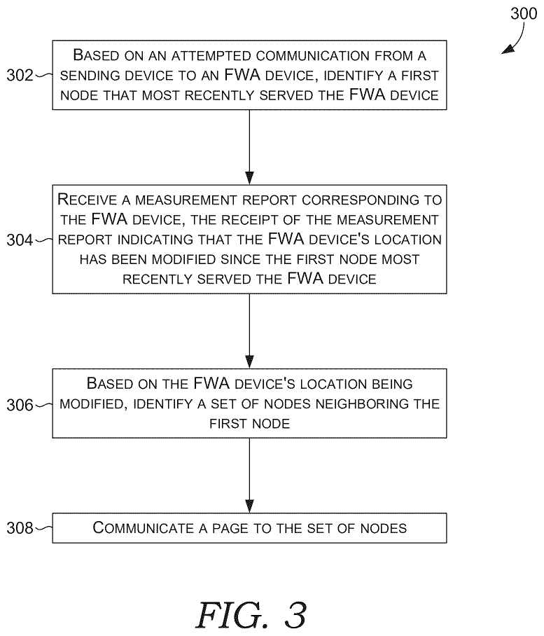

Turning now to FIG. 3, FIG. 3 illustrates another example flowchart of a method 300 for facilitating signaling reduction for an FWA device, in accordance with aspects herein. At block 302, based on an attempted communication from a sending device to an FWA device, a first node is identified that most recently served the FWA device. At block 304, a measurement report corresponding to the FWA device is received, where the receipt of the measurement report indicates that the FWA device's location has been modified since the first node most recently served the FWA device. At block 306, based on the FWA device's location being modified, a set of nodes neighboring the first node is identified. At block 308, a page is communicated to the set of nodes. In some aspects herein, only the first node and the set of nodes receive a paging message associated with the sending device attempting to communicate with the FWA device. Contrary to traditional paging methods where many more nodes are paged for mobile devices, herein, only the first node (e.g., last known node) and neighboring nodes may receive paging messages. In some aspects, prior to the page being communicated to the set of nodes, a first page may be communicated to a first node that is the last known node associated with the FWA device.

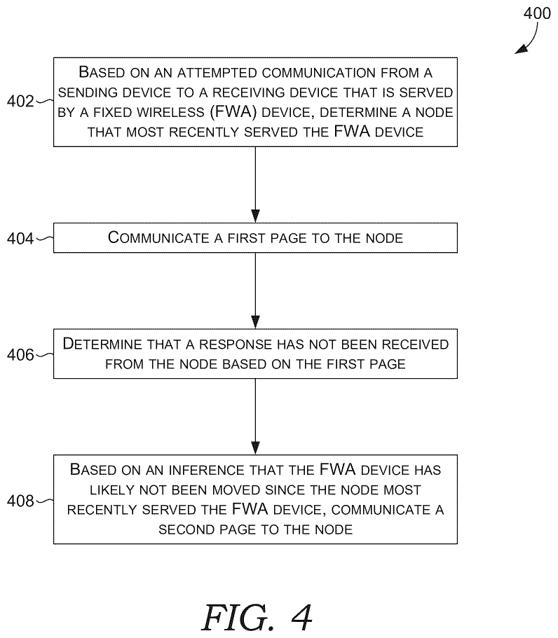

FIG. 4 illustrates another example flowchart of a method 400 for facilitating signaling reduction for an FWA device, in accordance with aspects herein. At block 402, based on an attempted communication from a sending device to a receiving device that is served by an FWA device, a node in a telecommunications network that most recently served the FWA device is determined. At block 404, a first page is communicated to the node. At block 406, it is determined that a response has not been received from the node based on the first page. At block 408, based on an inference that the FWA device has likely not been moved since the node most recently served the FWA device, a second page is communicated to the node. In aspects, it may be determined that a response has not been received from the node based on the second page. In this case, a third page may be communicated to the node. A time period between communication of the second page and the third page is greater than a time period between the communication of the first page and the second page, thus giving more time between subsequent pages. In aspects, a measurement report may be received by the network. In some cases, receipt of a measurement report from an FWA device may indicate that the FWA device was triggered to send it based on detection of its movement, such as if its location has been modified. In this case, a third page may be communicated to at least a second node that is different than the node.

Having described the example embodiments discussed above of the presently disclosed technology, an example operating environment of an example user device (e.g., user device 102A of FIG. 1) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 514, and one or more radios 516.

Bus 502 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 506 can execute instructions, for example, of an operating system of the user device 500 or of one or more suitable applications.

The one or more presentation components 508 can present data indications via user device 500, another user device, or a combination thereof. Example presentation components 508 may include a display device, speaker, printing component, vibrating component, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 508 can present a visualization that compares a plurality of inspections of one or more cores of a central processing unit and a visualization of each task of each of the plurality of inspections.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 508 of the user device 500 to render immersive augmented reality or virtual reality.

The power supply 514 of user device 500 may be implemented as one or more batteries or another power source for providing power to components of the user device 500. In embodiments, the power supply 514 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 516 (or similar wireless communication components). The one or more radios 516 can transmit, receive, or both transmit and receive signals for wireless communications. In embodiments, the user device 500 may be a wireless terminal adapted to receive communications and media over various wireless networks. User device 500 may communicate using the one or more radios 516 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 516 may facilitate communication via radio frequency signals, frames, blocks, transmission streams, packets, messages, data items, data, another type of wireless communication, or one or more combinations thereof. The one or more radios 516 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for facilitating signaling reduction for fixed wireless access (FWA) devices, the method comprising:
based on an attempted communication from a sending device to an FWA device, identifying a node in a telecommunications network that most recently served the FWA device;
communicating a first page to the node;
determining that a response has not been received from the node based on the first page; and
communicating a second page to the node.

2. The method according to claim 1, wherein the attempted communication is a data communication, a voice communication, or an upgrade to software on the FWA device.

3. The method according to claim 1, wherein the second page is communicated to the node without first communicating a page to one or more neighboring nodes or other cells of the node.

4. The method according to claim 1, further comprising prior to identifying the node that most recently served the FWA device, determining that a receiving device that is to receive the attempted communication is the FWA device.

5. The method according to claim 4, further comprising inferring that the FWA device is a non-mobile device.

6. The method according to claim 5, further comprising receiving an updated measurement report from the FWA device, the receipt of the updated measurement report indicating that the FWA device has been moved.

7. The method according to claim 6, further comprising based on the FWA device having been moved, communicating a third page to at least a second node that is different than the node.

8. The method according to claim 4, further comprising accessing historical data corresponding to the FWA device to determine that a probability that the FWA device has moved since the node most recently served the FWA device is below a threshold.

9. The method according to claim 1, further comprising:
determining that a response has not been received from the node based on the second page; and
communicating a third page to the node.

10. The method according to claim 9, wherein a time period between the communication of the second page and the third page is greater than a time period between the communication of the first page and the second page.

11. A system for facilitating signaling reduction for fixed wireless access (FWA) devices, the system comprising:
a network component associated with a wireless telecommunication network;
one or more processors communicatively coupled with the network component; and
computer memory storing computer-usable instructions that, when executed by the one or more processors, perform operations comprising:
based on an attempted communication from a sending device to an FWA device, identifying a first node that most recently served the FWA device;
receiving a measurement report corresponding to the FWA device, the receipt of the measurement report indicating that the FWA device's location has been modified since the first node served the FWA device;
based on the FWA device's location being modified, identifying a set of nodes neighboring the first node; and
communicating a page to the set of nodes.

12. The system according to claim 11, further comprising prior to communicating the page to the set of nodes, communicating a first page to the first node.

13. The system according to claim 11, wherein the FWA device is triggered to send the measurement report when it detects movement.

14. The system according to claim 11, wherein the attempted communication is a data communication, a voice communication, or an upgrade to software on the FWA device.

15. One or more non-transitory computer storage media having computer-executable instructions embodied thereon, that when executed by at least one processor, cause the at least one processor to perform a method comprising:
based on an attempted communication from a sending device to a receiving device that is served by a fixed wireless access (FWA) device, determining a node in a telecommunications network that most recently served the FWA device;
communicating a first page to the node;
determining that a response has not been received from the node based on the first page; and
based on an inference that the FWA device has likely not been moved since the node most recently served the FWA device, communicating a second page to the node.

16. The method according to claim 15, further comprising:
determining that a response has not been received from the node based on the second page; and
communicating a third page to the node.

17. The method according to claim 16, wherein a time period between the communication of the second page and the third page is greater than a time period between the communication of the first page and the second page.

18. The method according to claim 15, further comprising receiving an updated measurement report from the FWA device, the receipt of the updated measurement report indicating that the FWA device has been moved.

19. The method according to claim 18, further comprising based on the FWA device having been moved, communicating a third page to at least a second node that is different than the node.

20. The method according to claim 15, wherein the attempted communication is a data communication, a voice communication, or an upgrade to software on the FWA device.
